(19) United States
(12) Patent Application Publication
(10) Pub. No.: US 2024/0259358 A1
(43) Pub. Date: Aug. 1, 2024

(54) COMMUNICATION METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventor: Junling MAO, Shenzhen (CN)

(73) Assignee: Tencent Technology (Shenzhen) Company Limited, Shenzhen (CN)

(21) Appl. No.: 18/633,872

(22) Filed: Apr. 12, 2024

Related U.S. Application Data
(63) Continuation of application No. PCT/CN2023/086309, filed on Apr. 4, 2023.

(30) Foreign Application Priority Data
Jun. 15, 2022 (CN) 202210681586.7

(51) Int. Cl. H04L 9/40; H04L 9/08; H04L 9/32

(52) U.S. Cl. CPC H04L 63/0457; H04L 9/0825; H04L 9/3247

(57) ABSTRACT

A communication method/apparatus, including accessing a signaling server to trigger bidirectional authentication between the first terminal and the signaling server, generating a video connection establishment request based on the bidirectional authentication between the first terminal and the signaling server succeeding, signing the video connection establishment request; encrypting the video connection establishment request and a signature of the video connection establishment request to obtain a first encryption result, and transmitting the first encryption result to a second terminal via the signaling server.

### CROSS-REFERENCE TO RELATED APPLICATIONS

This application is a continuation application of International Application No. PCT/CN2023/086309 filed on Apr. 4, 2023, which claims priority to Chinese Patent Application No. 202210681586.7 filed with the China National Intellectual Property Administration on Jun. 15, 2022, the disclosures of each being incorporated by reference herein in their entireties.

### FIELD

Embodiments of the disclosure relate to the field of communication technologies, and in particular, to a communication method and apparatus, a device, a storage medium, and a program product.

### BACKGROUND

In in-vehicle video application scenarios such as a sentry mode and remote driving, a vehicle terminal and a user terminal may perform video transmission based on a Web Real-Time Communication (webRTC) point to point (P2P) mechanism, so that a user may view a vehicle terminal video or remotely drive through the user terminal.

At a stage of initiating a video connection, information related to establishing the video connection, such as a Session Description Protocol (SDP) and Interactive Connectivity Establishment (ICE), may be exchanged between the user terminal and the vehicle terminal through a signaling server. At a video transmission stage, the user terminal and the vehicle terminal may exchange video encryption keys through Datagram Transport Layer Security (DTLS). Further, the user terminal and the vehicle terminal may use the video encryption key to encrypt the video transmission through a Secure Real-time Transport Protocol (SRTP). In an SDP process, the user terminal may transmit a video connection establishment request to the vehicle terminal. A DTLS parameter, including, for example, a signature of a public key certificate of the user terminal may be transferred through the request. The parameter carried in the request directly affects whether the video encryption key may be securely transmitted, and further affect whether the video may be securely transmitted.

In the related art, the user terminal forwards the video connection establishment request to the vehicle terminal through the signaling server, which has a problem of low security of transmission of the request, and consequently causes low security of transmission of the video.

### SUMMARY

Some embodiments provide a communication method and apparatus, a device, a storage medium, and a program product, so that secure transmission of a video connection establishment request may be ensured, thereby ensuring security of video transmission.

Some embodiments provide a communication method, performed by a first terminal, including accessing a signaling server to trigger bidirectional authentication between the first terminal and the signaling server; generating a video connection establishment request based on the bidirectional authentication between the first terminal and the signaling server succeeding; signing the video connection establishment request; encrypting the video connection establishment request and a signature of the video connection establishment request to obtain a first encryption result; and transmitting the first encryption result to a second terminal via the signaling server.

Some embodiments provide a communication apparatus including: at least one memory configured to store program code; and at least one processor configured to read the program code and operate as instructed by the program code, the program code comprising: processing code configured to cause at least one of the at least one processor to: access a signaling server to trigger bidirectional authentication between a first terminal and the signaling server, generate a video connection establishment request based on the bidirectional authentication between the first terminal and the signaling server succeeding, sign the video connection establishment request, and encrypt the video connection establishment request and a signature of the video connection establishment request to obtain a first encryption result; and communication code configured to cause at least one of the at least one processor to: transmit the first encryption result to a second terminal via the signaling server.

Some embodiments provide a non-transitory computer-readable storage medium, storing computer code which, when executed by at least one processor, causes at least one of the at least one processor to at least: access a signaling server to trigger bidirectional authentication between the first terminal and the signaling server; generate a video connection establishment request based on the bidirectional authentication between the first terminal and the signaling server succeeding; sign the video connection establishment request; encrypt the video connection establishment request and a signature of the video connection establishment request to obtain a first encryption result; and transmit the first encryption result to a second terminal via the signaling server.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a flowchart of a video transmission method based on a webRTC P2P mechanism.

FIG. 2 illustrates an application scenario diagram according to some embodiments.

FIG. 3 is an interaction flowchart of a communication method according to some embodiments.

FIG. 4 is an interaction flowchart of another communication method according to some embodiments.

FIG. 5 is an interaction flowchart of yet another communication method according to some embodiments.

FIG. 6 is an interaction flowchart of yet another communication method according to some embodiments.

FIG. 7 is a schematic diagram of a communication apparatus 700 according to some embodiments.

FIG. 8 is a schematic diagram of a communication apparatus 800 according to some embodiments.

FIG. 9 is a schematic block diagram of an electronic device 900 according to some embodiments.

### DESCRIPTION OF EMBODIMENTS

According to some embodiments, since the bidirectional authentication between the first terminal and the signaling server is successful and the bidirectional authentication between the second terminal and the signaling server is successful, even if an illegal user terminal misappropriates an identifier of the first terminal, since the illegal user terminal does not register with the signaling server, and does not have a CA certificate of the signaling server, which causes bidirectional authentication between the illegal user terminal and the signaling server to fail. Based on this, another illegal user terminal may be prevented from accessing the signaling server, that is, the legitimacy of a source of a video establishment request, that is, the first terminal, may be ensured. Second, since the signaling server transmits the encryption result of the video connection establishment request and the signature of the video connection establishment request, that is, the first encryption result, to the second terminal based on the mapping relationship between the first terminal and the second terminal, so that the video connection request may be transmitted to the second terminal in a targeted manner, rather than to another terminal device. Third, the first terminal may perform signature encryption transmission on the video connection establishment request, thereby preventing an illegal signaling server from tampering with the video connection establishment request. Based on this, through the foregoing three aspects, the secure transmission of the video connection establishment request may be ensured, thereby ensuring security of video transmission.

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The terms “first” and “second” in the description and claims of the present disclosure and the foregoing accompanying drawings are used to distinguish between similar objects, but are not necessarily used to describe a specific order or sequence. It should be understood that the data used in such a way may be interchanged in an appropriate condition, so that the embodiments of the present disclosure described herein can be implemented in an order other than those illustrated or described herein. Moreover, the terms “comprise”, “include” and any other variants mean to cover the non-exclusive inclusion. For example, a process, method, system, product, or device that includes a list of steps or units is not necessarily limited to those steps or units, but may include other steps or units not expressly listed or inherent to such a process, method, product, or device.

Before the technical solutions are described, relevant knowledge of the technical solutions is explained below:

Bidirectional authentication: to-be-authenticated parties need to authenticate identities with each other.

Symmetric key encryption: also referred to as private key encryption or shared key encryption, that is, both parties transmitting and receiving data use a same key to encrypt and decrypt plaintext.

Asymmetric keys: a pair of keys, one key for encryption and the other key for decryption.

Signature: also referred to as a digital signature, a string of numbers that can only be generated by a sender of information and cannot be forged by others. This digital string is also a valid proof of the authenticity of the information transmitted by the sender of the information. The digital signature is an application of asymmetric key encryption technologies and digital digest technologies. For example, the signature may be implemented by using a Secure Hash algorithm (Secure Hash Algorithm, SHA) 256+RSA algorithm.

RSA: it is currently the most influential public key encryption algorithm, which is resistant to all cryptographic attacks known so far, has been recommended as a public key data encryption standard by the international organization for standardization (ISO). RSA is an asymmetric encryption algorithm, that is, an encryption key is different from a decryption key, content encrypted using a private key can only be decrypted by a public key, and content encrypted using a public key can only be decrypted by a private key.

SHA-256: for any length message, SHA256 generates a 256-bit hash value referred to as a message digest. The digest is equivalent to an array of 32 bytes in length, typically represented by a hexadecimal string of length 64, where 1 byte=8 bits and a hexadecimal character is 4 bits in length.

Certificate: including a public key value of a principal, principal identifier information, a validity period, issuer identifier information, a signature of an issuer.

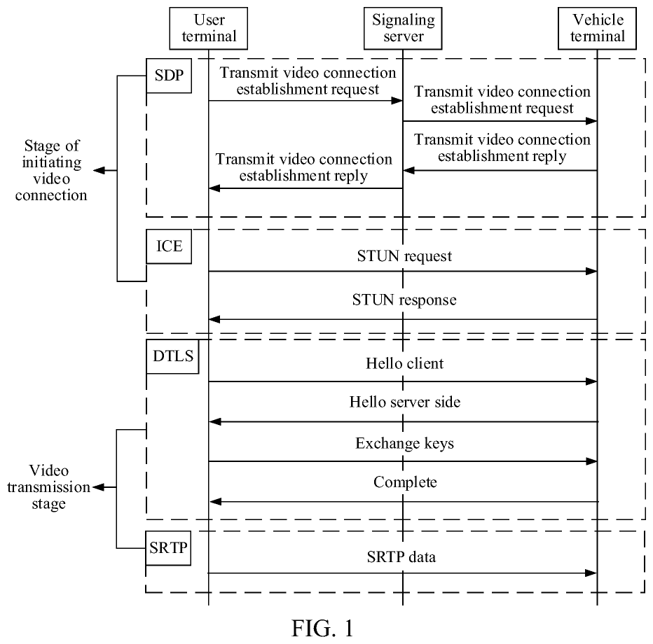

FIG. 1 is a flowchart of a video transmission method based on a webRTC P2P mechanism. As shown in FIG. 1, the video transmission method includes: a stage of initiating a video connection and a video transmission stage. At the stage of initiating the video connection, a user terminal may transmit a video connection establishment request (offer) to a vehicle terminal through a signaling server by using an SDP protocol, and receive a video connection establishment reply (answer) transmitted by the vehicle terminal through the signaling server by using the SDP protocol. The offer may carry at least one of the following, but is not limited thereto:
a=ice-ufrag:khLS;
a=ice-pwd:cxLzteJaJBou3DspNaPsJhIQ;
a=fingerprint:sha-256
FA:14:42:3B:C7:97:1B:E8: AE:0C2:71:03:05:05:16:8F:B9:C7:98:E9:60:43:4B:5B:2C:28:EE:5C:8F 3:17 a=setup:actpass
where a=ice-ufrag:khLS is a session identifier, a=ice-pwd:cxLzteJaJBou3DspNaPsJhlQ is a key used by an ICE stage, a=fingerprint:sha-256 is a signature of a public key certificate of a user terminal to be used in a DTLS procedure, a=setup:actpass is an operating mode, including: a client and/or server mode.

The vehicle terminal may carry confirmation and selection of information in the offer in the answer.

Further, the user terminal may transmit a simple traversal of user datagram protocol (UDP) through network address translators (NAT) (STUN) request for network address translation to the vehicle terminal, and receive a STUN response transmitted by the vehicle terminal to find a path between the user terminal and the vehicle terminal.

At the video transmission stage, the user terminal interacts with the vehicle terminal through DTLS signaling to exchange a video encryption key. Further, the user terminal and the vehicle terminal may use the video encryption key to encrypt the video transmission through SRTP.

As described above, the offer may transfer the DTLS parameter, including, for example, a signature of the public key certificate of the user terminal. The parameter carried in the offer directly affects whether the video encryption key may be securely transmitted, and further affect whether the video may be securely transmitted. The user terminal forwards the video connection establishment request to the vehicle terminal through the signaling server, which has a problem of low security of transmission of the request, and consequently causes low security of transmission of the video.

To resolve the foregoing technical problem, a secure mapping relationship between the vehicle terminal and the user terminal may be constructed, and the foregoing request may be performed signature encryption transmission.

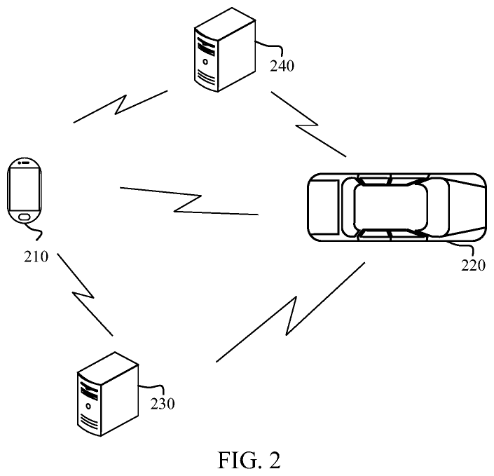

FIG. 2 illustrates an application scenario diagram according to some embodiments. As shown in FIG. 2, a user terminal 210 and a vehicle terminal 220 may each communicate with a signaling server 230 to establish a video connection. The established video connection may be a P2P mode video connection, that is, direct communication between the user terminal 210 and the vehicle terminal 220, or the established video connection may further be a forwarding-based video connection, that is, forwarding communication is implemented between the user terminal 210 and the vehicle terminal 220 through a forwarding server 240.

In some embodiments, the forwarding server 240 may be a same server as the signaling server 230, or may be different servers.

In some embodiments, the user terminal 210, the vehicle terminal 220, and the signaling server 230 may be directly or indirectly connected in a wired or wireless communication manner. This is not limited herein. For example, communication between the user terminal 210, the vehicle terminal 220, and the signaling server 230 may be based on a 5th Generation (5G) communication system, a 4th Generation (4G) communication system, a 3th Generation (3G) communication system, Wireless Fidelity (WiFi), or another wireless communication technology.

In some embodiments, the user terminal 210 may be a mobile phone, a computer, an intelligent voice interaction device, a smart household appliance, an in-vehicle terminal, an aircraft, or the like, but is not limited thereto.

In some embodiments, the signaling server 230 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform.

In some embodiments, the forwarding server 240 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform.

Embodiments may be applied to various scenarios, including but not limited to, cloud technology, artificial intelligence, intelligent transportation, assisted driving, and the like. For example, embodiments may be applied to in-vehicle video application scenarios such as sentry mode and remote driving.

It is to be understood that sentry mode refers to the detection of potential threats by an external camera of a vehicle, for example, detecting whether someone is approaching the vehicle or whether the vehicle has been damaged.

The technical solutions of some embodiments are described in detail in the following:

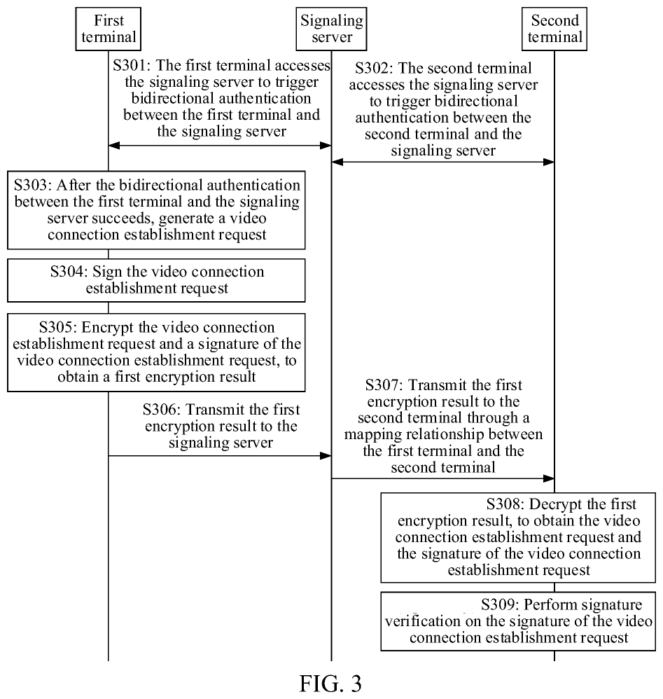

FIG. 3 is an interaction flowchart of a communication method according to some embodiments. An execution body involved in this method may include: a first terminal, a second terminal, and a signaling server. The first terminal may be the user terminal 210 in FIG. 2, and the second terminal may be the vehicle terminal 220 in FIG. 2, but is not limited thereto. As shown in FIG. 3, the method includes:
S301: The first terminal accesses the signaling server to trigger bidirectional authentication between the first terminal and the signaling server.
S302: The second terminal accesses the signaling server to trigger bidirectional authentication between the second terminal and the signaling server.
S303: After the bidirectional authentication between the first terminal and the signaling server succeeds, the first terminal generates a video connection establishment request.
S304: The first terminal signs the video connection establishment request.
S305: The first terminal encrypts the video connection establishment request and a signature of the video connection establishment request, to obtain a first encryption result.
S306: The first terminal transmits the first encryption result to the signaling server.
S307: The signaling server transmits the first encryption result to the second terminal through a mapping relationship between the first terminal and the second terminal.

In some embodiments, the method may further include:
S308: The second terminal decrypts the first encryption result, to obtain the video connection establishment request and the signature of the video connection establishment request.
S309: The second terminal performs signature verification on the signature of the video connection establishment request.

In some embodiments, the signaling server may establish the mapping relationship between the first terminal and the second terminal. Based on this, after receiving the first encryption result, the signaling server may transmit the first encryption result to the second terminal based on the mapping relationship, and may not transmit the first encryption result to another terminal.

In some embodiments, before the first terminal and the second terminal access the signaling server, the first terminal and the second terminal may register on the signaling server, the first terminal may register at least one of a token, a certification authority (CA) certificate, and hardware information of the terminal to the signaling server. The second terminal may register at least one of a token, a CA certificate, and hardware information of the second terminal to the signaling server, and the user may further configure the second terminal with a user password for the second terminal. Both the first terminal and the second terminal may be configured with the CA certificate of the signaling server. Based on this, bidirectional authentication between the first terminal and the signaling server and bidirectional authentication between the second terminal and the signaling server are implemented.

In some embodiments, the hardware information may include at least one of the following, but not limited to, a chip serial number, a medium access control (MAC) address.

In some embodiments, the user may initiate a video connection through an application (APP) on the first terminal for implementing the video transmission of the first terminal with the second terminal, select the second terminal to be connected, and may further enter the user password of the second terminal. When the user initiates a video connection through the APP, the first terminal accesses the signaling server. After the user selects the second terminal, the second terminal accesses the signaling server.

In some embodiments, if the signaling server is registered with at least one of the token and the hardware information of the first terminal, a bidirectional authentication process between the first terminal and the signaling server may be as follows: the first terminal generates a random number, encrypts the random number by a public key in a CA certificate of the signaling server, transmits an encryption result to the signaling server, the signaling server decrypts the encryption result through a private key corresponding to the CA certificate and encrypts the decryption result by the private key, compares whether the encryption result obtained from the first terminal and the encryption result generated by itself are consistent, and if they are consistent, the first terminal successfully authenticates the signaling server, and if they are inconsistent, the first terminal fails to authenticate the signaling server. The first terminal may encrypt at least one of the own token and the hardware information by using a hash algorithm and transmit the encryption result to the signaling server, the signaling server may further encrypt at least one of the hardware information of the first terminal by using a same hash algorithm, to obtain an encryption result, and compare whether the two encryption results are consistent. If the two encryption results are consistent, the signaling server successfully authenticates the first terminal, and if two encryption results are inconsistent, the signaling server fails to authenticate the first terminal.

In some embodiments, if the signaling server is registered with the CA certificate of the first terminal, an authentication process of the first terminal to the signaling server may refer to the foregoing. The authentication process of the signaling server to the first terminal may be as follows: the signaling server may generate a random number, encrypt the random number by a public key in a CA certificate of the first terminal, transmit an encryption result to the first terminal, the first terminal decrypts by a private key corresponding to the CA certificate and encrypts the decryption result through the private key, compare whether the encryption result obtained from the signaling server and the encryption result generated by itself are consistent, and if they are consistent, the signaling server successfully authenticates the first terminal, and if they are inconsistent, the signaling server fails to authenticate the first terminal.

In some embodiments, if the signaling server is registered with at least one of the token and the hardware information of the first terminal and the CA certificate, the authentication process of the first terminal to the signaling server may refer to the foregoing. The authentication processes of the signaling server for the first terminal may be as follows: the first terminal may encrypt at least one of its own token and hardware information by using a hash algorithm and transmit the encryption result to the signaling server, the signaling server may further encrypt at least one of the hardware information of the first terminal by using the same hash algorithm to obtain an encryption result, and the signaling server may compare the two encryption results. The signaling server may generate a random number, encrypt the random number through a public key in a CA certificate of the first terminal, transmit the encryption result to the first terminal, the first terminal decrypts the decryption result through a private key corresponding to the CA certificate, encrypts the decryption result through the private key, and compares whether the encryption result obtained from the signaling server and the encryption result generated by itself are consistent. If the signaling server determines that two sets of encryption results are consistent, the signaling server successfully authenticates the first terminal, and if the signaling server determines that at least one of the two sets of encryption results is inconsistent, the signaling server fails to authenticate the first terminal.

It is to be understood that, with respect to the bidirectional authentication process between the second terminal and the signaling server, reference may be made to the bidirectional authentication process between the first terminal and the signaling server. Details are not described herein.

It is to be understood that, if the bidirectional authentication between the first terminal and the signaling server succeeds, and the bidirectional authentication between the second terminal and the signaling server succeeds, even if an illegal user terminal steals an identifier of the first terminal, the illegal user terminal does not register an identity on the signaling server, and does not have the CA certificate of the signaling server, which causes the bidirectional authentication between the illegal user terminal and the signaling server to fail. As used herein, illegal may refer to unauthorized and/or unauthenticated, and legal may refer to authorized and/or authenticated.

In some embodiments, the video connection establishment request may or may not be exactly the same as the video connection establishment request in FIG. 1. For example, the request may include at least one of the following: a public key certificate of first asymmetric keys, a signature of the public key certificate, an audio and video parameter, an identifier of the requested video transmission mode, an identifier of a distribution algorithm of a video encryption key, an identifier of the first terminal, an identifier of the second terminal, a timestamp, a session identifier, a key used in an ICE stage, and an operating mode.

In some embodiments, the first asymmetric keys are generated by the first terminal.

In some embodiments, the audio and video parameter includes: compressed encoding format, resolution, and the like, but are not limited thereto.

In some embodiments, the video transmission mode may be a P2P video transmission mode or a forwarding-based video transmission mode.

In some embodiments, the distribution algorithm of the video encryption key may be an RSA algorithm or a key exchange (Diffie-Hellman, DH) algorithm.

In some embodiments, in a remote driving scenario, the video connection establishment request may further include: establishing an identifier or the like of a data channel, where the data channel is configured for transmitting control information, such as control information for controlling a brake, and control information for controlling a throttle.

In some embodiments, the first terminal may sign the video connection establishment request by using an SHA256+RSA signature algorithm. In other words, the first terminal may first use the SHA256 algorithm on the video connection establishment request to obtain a hash value, that is, a digest, and then encrypt the hash value through RSA to obtain a signature of the video connection establishment request.

In some embodiments, the first terminal may sign the video connection establishment request by using a private key of the public key certificate of the first asymmetric keys or a third party key.

In some embodiments, the third party key may be a key generated by a signature server or an application server corresponding to the APP, and the first terminal may call back the signature server or the application server through a software development kit (SDK) to generate the third party key.

In some embodiments, if the video connection establishment request includes a signature of the public key certificate of the first asymmetric keys, the first terminal may sign the public key certificate of the first asymmetric keys with a private key of the public key certificate of the first asymmetric keys or a third party key, where signing the public key certificate of the first asymmetric keys with the private key of the public key certificate of the first asymmetric keys may be referred to as self-signing. Reference may be made to the foregoing for an explanation of the third party key.

It is to be understood that, the signature of the video connection establishment request is to prevent the video connection establishment request from being tampered with. However, the first terminal needs to transmit the video connection establishment request and a signature of the request to the second terminal through the signaling server. To prevent the video connection establishment request from being tampered with by an illegal signaling server, the video connection establishment request and the signature of the request need to be encrypted.

In some embodiments, the first terminal may encrypt the video connection establishment request and the signature of the request by using a user password of the second terminal, or may encrypt the video connection establishment request and the signature of the request by using a user password and a dynamic password of the second terminal.

In some embodiments, after receiving the first encryption result, the second terminal may further decrypt the first encryption result by using a same password as the first terminal. For example, when the first terminal encrypts the video connection establishment request and the signature of the request by using the user password of the second terminal, the second terminal further decrypts the first encryption result by using the user password of the second terminal. When the first terminal encrypts the video connection establishment request and the signature of the request by using the user password and the dynamic password of the second terminal, the second terminal further decrypts the first encryption result by using the user password and the dynamic password of the second terminal.

In some embodiments, the dynamic password uniquely corresponds to the session identifier, that is, a dynamic password corresponding to a same session identifier is the same. Based on this, it may be ensured that the dynamic passwords used by the first terminal and the second terminal are the same.

In some embodiments, after the second terminal obtains the video connection establishment request and the signature of the video connection establishment request, if the signature of the video connection establishment request is obtained by the SHA256+RSA algorithm, the second terminal may decrypt the signature through the public key of the public key certificate of the first asymmetric keys or the third party key to obtain a hash value, then the second terminal may use SHA256 for the video connection establishment request to obtain a hash value, and compare two hash values. If the two hash values are the same, it indicates that the signature of the video connection establishment request is authorized, otherwise, it indicates that the signature of the video connection establishment request is not authorized.

In some embodiments, if the video connection establishment request includes a signature of a public key certificate of the first asymmetric keys, the first terminal may further perform signature verification on the signature of the public key certificate after the video connection establishment request is successfully performed signature verification. A signature verification process may refer to a signature verification process of the video connection establishment request, and details are not described herein again.

In some embodiments, since the bidirectional authentication between the first terminal and the signaling server is successful and the bidirectional authentication between the second terminal and the signaling server is successful, even if an illegal user terminal misappropriates an identifier of the first terminal, since the illegal user terminal does not register with the signaling server, and does not have a CA certificate of the signaling server, which causes bidirectional authentication between the illegal user terminal and the signaling server to fail. Based on this, another illegal user terminal may be prevented from accessing the signaling server, that is, the legitimacy of a source of a video establishment request, that is, the first terminal, may be ensured. Since the signaling server transmits the encryption result of the video connection establishment request and the signature of the video connection establishment request, that is, the first encryption result, to the second terminal based on the mapping relationship between the first terminal and the second terminal, so that the video connection request may be transmitted to the second terminal in a targeted manner, rather than to another terminal device. The first terminal may perform signature encryption transmission on the video connection establishment request, thereby preventing an illegal signaling server from tampering with the video connection establishment request. Based on this, through the foregoing three aspects, the secure transmission of the video connection establishment request may be ensured, thereby ensuring security of video transmission.

Further, the signaling server may authenticate the first terminal and the second terminal based on the hardware information of the first terminal and the second terminal, which may reduce a risk of identity forgery of the first terminal and the second terminal.

It is to be understood that, to implement an objective of video connection establishment negotiation, after the first terminal transmits the video connection establishment request to the second terminal, the second terminal may transmit a video connection establishment reply to the first terminal.

It is to be understood that, the video connection establishment reply may carry confirmation, selection, and the like of information about the video connection establishment request.

In some embodiments, the video connection establishment reply may or may not be exactly the same as the video connection establishment reply in FIG. 1. For example, when the video connection establishment request includes an identifier of a requested video transmission mode, such as requesting a P2P video transmission mode, the second terminal may confirm whether the P2P video transmission mode is applicable.

In some embodiments, in a remote driving scenario, when the video connection establishment request includes an identifier of establishing a data channel, and the like, the video connection establishment reply may include agreement to establish the data channel and a certificate corresponding to each data channel. Subsequent data in the data channel may be signed by using a corresponding certificate.

In some embodiments, the second terminal may transmit the video connection establishment reply in plaintext form to the first terminal through the signaling server, or may perform signature encryption on the video connection establishment reply, and transmit the encryption result to the first terminal through the signaling server.

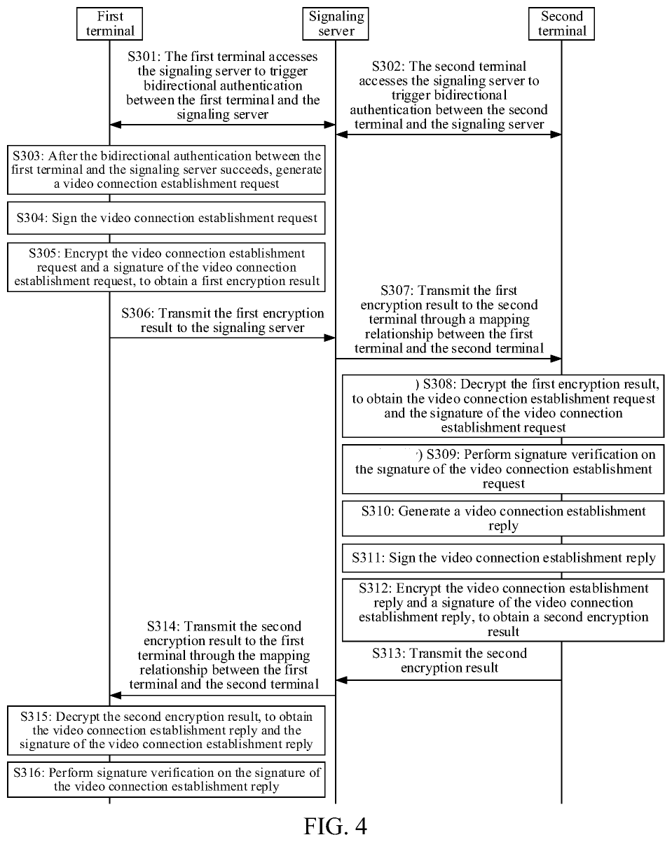

In some embodiments, as shown in FIG. 4, after the foregoing S309, the communication method may further include the following operations:
S310: The second terminal generates a video connection establishment reply.
S311: The second terminal signs the video connection establishment reply.
S312: The second terminal encrypts the video connection establishment reply and a signature of the video connection establishment reply, to obtain a second encryption result.
S313: The second terminal transmits the second encryption result to a signaling server.
S314: The signaling server transmits the second encryption result to the first terminal through a mapping relationship between the first terminal and the second terminal.
S315: The first terminal decrypts the second encryption result, to obtain the video connection establishment reply and the signature of the video connection establishment reply.
S316: Perform signature verification on the signature of the video connection establishment reply.

In some embodiments, the second terminal may sign the video connection establishment reply by using the SHA256+RSA signature algorithm. In other words, the second terminal may first use the SHA256 algorithm on the video connection establishment reply to obtain a hash value, that is, a digest, and then encrypt the hash value through RSA to obtain a signature of the video connection establishment reply.

In some embodiments, the second terminal may sign the video connection establishment reply by using the private key of the public key certificate of second asymmetric keys or a third party key.

In some embodiments, the second asymmetric keys are generated by the second terminal.

It is to be understood that, if the second terminal signs the video connection establishment reply by using the private key of the public key certificate of the second asymmetric keys, the second terminal needs to transmit the public key certificate of the second asymmetric keys to the first terminal before transmitting the video connection establishment reply, so that the first terminal may perform signature verification on the signature of the video connection establishment reply through the public key in the public key certificate.

It is to be understood that, reference may be made to the foregoing for an explanation of the third party key, and details are not described in this application.

It is to be understood that, the signature of the video connection establishment reply is to prevent the video connection establishment reply from being tampered with. However, the second terminal needs to transmit the video connection establishment reply and a signature of the reply to the first terminal through the signaling server. To prevent the video connection establishment reply from being tampered with by an illegal signaling server, the video connection establishment reply and the signature of the reply need to be encrypted.

In some embodiments, the second terminal may encrypt the video connection establishment reply and the signature of the reply by using the user password of the second terminal, or may encrypt the video connection establishment reply and the signature of the reply by using the user password and the dynamic password of the second terminal.

In some embodiments, after receiving the second encryption result, the first terminal may further decrypt the second encryption result by using a same password as the second terminal. For example, when the second terminal encrypts the video connection establishment reply and the signature of the reply by using the user password of the second terminal, the first terminal further decrypts the second encryption result by using the user password of the second terminal. When the second terminal encrypts the video connection establishment reply and the signature of the reply by using the user password and the dynamic password of the second terminal, the first terminal further decrypts the second encryption result by using the user password and the dynamic password of the second terminal.

It is to be understood that, reference may be made to the foregoing for an explanation of the dynamic password, and details are not described herein.

In some embodiments, after the first terminal obtains the video connection establishment reply and the signature of the video connection establishment reply, if the signature of the video connection establishment reply is obtained by the SHA256+RSA algorithm, the first terminal may decrypt the signature through the public key of the public key certificate of the second asymmetric keys or the third party key to obtain a hash value, then the first terminal may use SHA256 for the video connection establishment reply to obtain a hash value, and compare two hash values. If the two hash values are the same, it indicates that the signature of the video connection establishment reply is legal, otherwise, it indicates that the signature of the video connection establishment reply is illegal.

In some embodiments, since the bidirectional authentication between the first terminal and the signaling server is successful and the bidirectional authentication between the second terminal and the signaling server is successful, even if an illegal user terminal misappropriates an identifier of the first terminal, since the illegal user terminal does not register with the signaling server, and does not have a CA certificate of the signaling server, which causes bidirectional authentication between the illegal user terminal and the signaling server to fail. Based on this, another illegal user terminal may be prevented from accessing the signaling server, that is, the legitimacy of a destination end of the video connection establishment reply, that is, the first terminal, may be ensured. Since the signaling server transmits the encryption result of the video connection establishment reply and the signature of the video connection establishment reply, that is, the second encryption result, to the first terminal based on the mapping relationship between the first terminal and the second terminal, so that the video connection reply may be transmitted to the first terminal in a targeted manner, rather than to another terminal device. The second terminal may perform signature encryption transmission on the foregoing video connection establishment reply, thereby preventing an illegal signaling server from tampering with the video connection establishment reply. Based on this, through the foregoing three aspects, the secure transmission of the video connection establishment reply may be ensured, thereby ensuring security of video transmission.

It is to be understood that, after performing the video connection establishment negotiation, the first terminal and the second terminal may find a path between the first terminal and the second terminal in the ICE stage and implement exchange of a video encryption key based on the path, thereby implementing video transmission. However, in some embodiments, the video transmission between the first terminal and the second terminal is not limited to the P2P video transmission mode, and the forwarding-based video transmission mode may further be used. In this case, the video connection establishment request may include an identifier of the requested video transmission mode, that is, the requested video transmission mode is P2P and/or forwarding-based video transmission mode, while a video connection suggestion reply may include the first video transmission mode determined by the second terminal, such as confirming that the P2P video transmission mode or the forwarding-based video transmission mode is subsequently used.

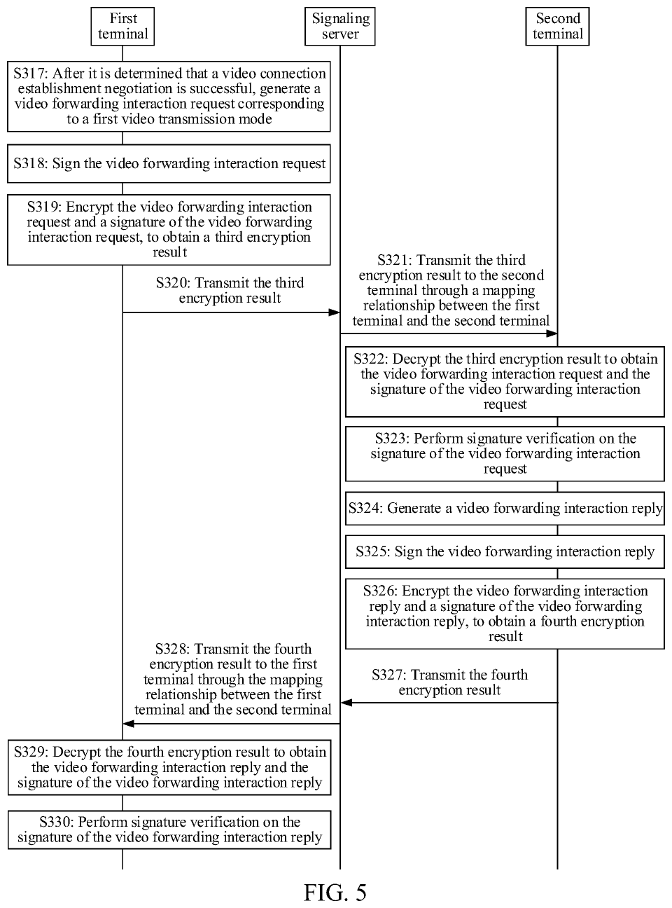

In some embodiments, as shown in FIG. 5, the communication method may further include the following operations:
S317: After it is determined that a video connection establishment negotiation is successful, the first terminal generates a video forwarding interaction request corresponding to a first video transmission mode.
S318: The first terminal signs the video forwarding interaction request.
S319: The first terminal encrypts the video forwarding interaction request and a signature of the video forwarding interaction request to obtain a third encryption result.
S320: The first terminal transmits the third encryption result to a signaling server.
S321: The signaling server transmits the third encryption result to a second terminal through a mapping relationship between the first terminal and the second terminal.
S322: The second terminal decrypts the third encryption result to obtain the video forwarding interaction request and the signature of the video forwarding interaction request.
S323: The second terminal performs signature verification on the signature of the video forwarding interaction request.
S324: The second terminal generates a video forwarding interaction reply.
S325: The second terminal signs the video forwarding interaction reply.
S326: The second terminal encrypts the video forwarding interaction reply and a signature of the video forwarding interaction reply to obtain a fourth encryption result.
S327: The second terminal transmits the fourth encryption result to the signaling server.
S328: The signaling server transmits the fourth encryption result to the first terminal through the mapping relationship between the first terminal and the second terminal.
S329: The first terminal decrypts the fourth encryption result to obtain the video forwarding interaction reply and the signature of the video forwarding interaction reply.
S330: The first terminal performs signature verification on the signature of the video forwarding interaction reply.
S317 to S330 may be performed after S316 described above.

In some embodiments, if the first video transmission mode is the P2P mode, a video forwarding interaction request corresponding to the first video transmission mode may be the same as the STUN request, which may include ICE parameters such as a transport address on a subnet, a transport address on NAT, and a forwarding address on a server by using relay extensions to session traversal utilities for NAT (STUN). Correspondingly, the video forwarding interaction reply may be the same as an STUN response, which may include a determined peer Internet Protocol (IP), port number, and the like, to form a path between the first terminal and the second terminal.

In some embodiments, if the first video transmission mode is the forwarding-based video transmission mode, the video forwarding interaction request corresponding to the first video transmission mode may include: an identifier of a requested forwarding server, a requested room number, and the like. Correspondingly, the video forwarding interaction reply may include: an identifier of a determined forwarding server, a determined room number, and the like.

In some embodiments, the first terminal may sign the video forwarding interaction request by using an SHA256+RSA signature algorithm. In other words, the first terminal may first use the SHA256 algorithm to obtain a hash value, that is, a digest, on the video forwarding interaction request, and then encrypt the hash value through RSA to obtain a signature of the video forwarding interaction request.

In some embodiments, the first terminal may sign the video forwarding interaction request by using a private key of the public key certificate of the first asymmetric keys or a third party key.

It is to be understood that, reference may be made to the foregoing for an explanation of the third party key, and details are not described herein.

It is to be understood that, the signature of the video forwarding interaction request is to prevent the video forwarding interaction request from being tampered with. However, the first terminal needs to transmit the video forwarding interaction request and a signature of the request to the second terminal through the signaling server. To prevent the video forwarding interaction request from being tampered with by an illegal signaling server, the video forwarding interaction request and the signature of the request need to be encrypted.

In some embodiments, the first terminal may encrypt the video forwarding interaction request and the signature of the request by using the user password of the second terminal, or may encrypt the video forwarding interaction request and the signature of the request by using the user password and the dynamic password of the second terminal.

In some embodiments, after receiving the third encryption result, the second terminal may further decrypt the third encryption result by using a same password as the first terminal. For example, when the first terminal encrypts the video forwarding interaction request and a signature of the request by using the user password of the second terminal, the second terminal further decrypts the third encryption result by using the user password of the second terminal. When the first terminal encrypts the video forwarding interaction request and the signature of the request by using the user password and the dynamic password of the second terminal, the second terminal further decrypts the third encryption result by using the user password and the dynamic password of the second terminal.

In some embodiments, reference may be made to the foregoing for an explanation of the dynamic password, and details are not described again.

In some embodiments, after the second terminal obtains the video forwarding interaction request and a signature of the video forwarding interaction request, if the signature of the video forwarding interaction request is obtained by the SHA256+RSA algorithm, the second terminal may decrypt the signature through the public key of the public key certificate of the first asymmetric keys or the third party key to obtain a hash value, then the second terminal may use SHA256 for the video forwarding interaction request to obtain a hash value, and compare two hash values. If the two hash values are the same, it indicates that the signature of the video forwarding interaction request is legal, otherwise, it indicates that the signature of the video forwarding interaction request is illegal.

In some embodiments, the second terminal may sign the video forwarding interaction reply by using the SHA256+RSA signature algorithm. In other words, the second terminal may first use the SHA256 algorithm on the video forwarding interaction reply to obtain a hash value, that is, a digest, and then encrypt the hash value through RSA to obtain a signature of the video forwarding interaction reply.

In some embodiments, the second terminal may sign the video forwarding interaction reply by using the private key of the public key certificate of the second asymmetric keys or the third party key.

It is to be understood that, reference may be made to the foregoing for an explanation of the third party key, and details are not described again.

It is to be understood that, the signature of the video forwarding interaction reply is to prevent the video forwarding interaction reply from being tampered with. However, the second terminal needs to transmit the video forwarding interaction reply and a signature of the reply to the first terminal through the signaling server. To prevent the video forwarding interaction reply from being tampered with by an illegal signaling server, the video forwarding interaction reply and the signature of the reply need to be encrypted.

In some embodiments, the second terminal may encrypt the video forwarding interaction reply and the signature of the reply by using the user password of the second terminal, or may encrypt the video forwarding interaction reply and the signature of the reply by using the user password and the dynamic password of the second terminal.

In some embodiments, after receiving the fourth encryption result, the first terminal may further decrypt the fourth encryption result by using a same password as the second terminal. For example, when the second terminal encrypts the video forwarding interaction reply and the signature of the reply by using the user password of the second terminal, the first terminal further decrypts the fourth encryption result by using the user password of the second terminal. When the second terminal encrypts the video forwarding interaction reply and the signature of the reply by using the user password and the dynamic password of the second terminal, the first terminal further decrypts the fourth encryption result by using the user password and the dynamic password of the second terminal.

It is to be understood that, reference may be made to the foregoing for an explanation of the dynamic password, and details are not described again.

In some embodiments, after the first terminal obtains the video forwarding interaction reply and the signature of the video forwarding interaction reply, if the signature of the video forwarding interaction reply is obtained by the SHA256+RSA algorithm, the first terminal may decrypt the signature through the public key of the public key certificate of the second asymmetric keys or the third party key to obtain a hash value, then the first terminal may use SHA256 for the video forwarding interaction reply to obtain a hash value, and compare two hash values. If the two hash values are the same, it indicates that the signature of the video forwarding interaction reply is legal, otherwise, it indicates that the signature of the video forwarding interaction reply is illegal.

In some embodiments, since the bidirectional authentication between the first terminal and the signaling server is successful and the bidirectional authentication between the second terminal and the signaling server is successful, even if an illegal user terminal misappropriates an identifier of the first terminal, since the illegal user terminal does not register with the signaling server, and does not have a CA certificate of the signaling server, which causes bidirectional authentication between the illegal user terminal and the signaling server to fail. Based on this, another illegal user terminal may be prevented from accessing the signaling server, that is, the legitimacy of a source end of the video forwarding interaction request and a destination end of the video forwarding interaction reply, that is, the first terminal, may be ensured. Since the signaling server transmits the foregoing third encryption result and fourth encryption result based on the mapping relationship between the first terminal and the second terminal, so that transmission of the video forwarding interaction request and the video forwarding interaction reply may be implemented in a targeted manner. The first terminal may perform signature encryption transmission of the foregoing video forwarding interaction request, thereby preventing an illegal signaling server from tampering with the video forwarding interaction request. The second terminal may further perform signature encryption transmission of the foregoing video forwarding interaction reply, thereby preventing the illegal signaling server from tampering with the video forwarding interaction reply. Based on this, through the foregoing three aspects, the video forwarding interaction request and the video forwarding interaction reply may be ensured, thereby ensuring security of video transmission.

It is to be understood that, a corresponding embodiment in FIG. 5 implements the establishment of a path between the first terminal and the second terminal. Based on this, in a subsequent process, the first terminal and the second terminal may use the path to transmit the video encryption key and the video. In some scenarios, such as a sentry mode scenario, the vehicle terminal only needs to transmit the video to the user terminal. This video transmission process is a unidirectional video transmission process. While in some other scenarios, such as a remote driving scenario, the vehicle terminal and the user terminal need to transmit video to each other. This video transmission is a bidirectional video transmission process. The two video transmission processes are described in the following:

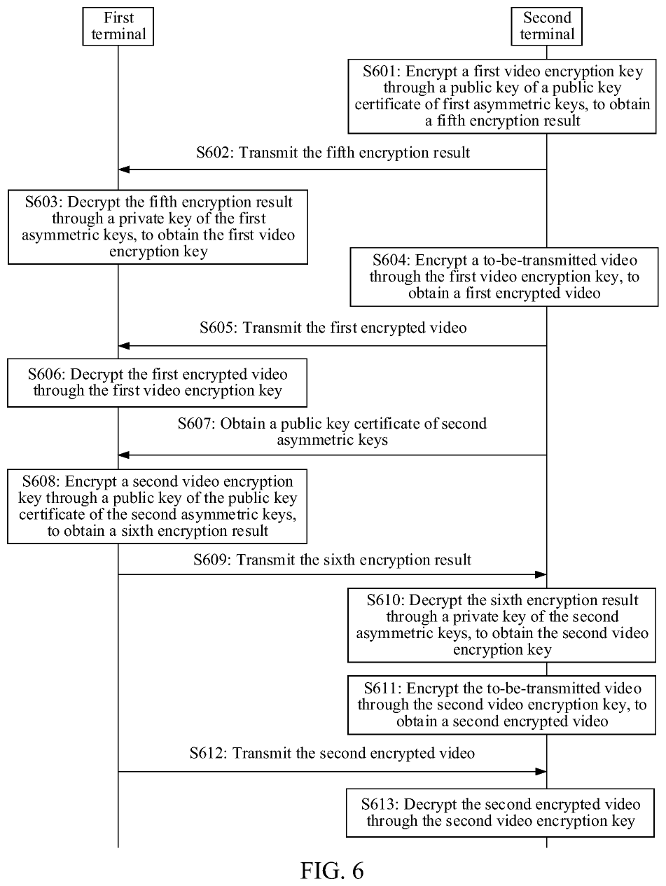

FIG. 6 is an interaction flowchart of a communication method according to some embodiments. As shown in FIG. 6, the method includes:
S601: The second terminal encrypts a first video encryption key through a public key of a public key certificate of first asymmetric keys to obtain a fifth encryption result.
S602: The second terminal transmits the fifth encryption result to the first terminal.
S603: The first terminal decrypts the fifth encryption result through a private key of the first asymmetric keys, to obtain the first video encryption key.
S604: The second terminal encrypts a to-be-transmitted video through the first video encryption key, to obtain a first encrypted video.
S605: The second terminal transmits the first encrypted video to the first terminal.
S606: The first terminal decrypts the first encrypted video through the first video encryption key.

In some embodiments, when the video transmission mode used by the first terminal and the second terminal is a P2P transmission mode, then in this embodiment, all transmission contents of the first terminal and the second terminal are transmitted based on the P2P transmission mode. When the video transmission mode used by the first terminal and the second terminal is a forwarding-based video transmission mode, then in this embodiment, all transmission contents of the first terminal and the second terminal may be forwarded and transmitted through the forwarding server.

It is to be understood that, the distribution algorithm of the video encryption key used in this embodiment is the RSA algorithm, and actually, the DH algorithm may further be used.

It is to be understood that, in some embodiments, the second terminal encrypts the first video encryption key through the public key of the public key certificate of the first asymmetric keys. In some embodiments, the first video encryption key may be encrypted by using symmetric keys. In this case, the first terminal decrypts the fifth encryption result by using the symmetric keys, to obtain the first video encryption key.

In some embodiments, when the video transmission mode used by the first terminal and the second terminal is a P2P video transmission mode, the second terminal may transmit the first video encryption key by using a video transmission parameter corresponding to the P2P video transmission mode, for example, video transmission is performed based on the SRTP protocol. When the video transmission mode used by the first terminal and the second terminal is a forwarding-based video transmission mode, the second terminal may transmit the first video encryption key by using a video transmission parameter corresponding to the video transmission mode, for example, video transmission is performed based on the RTC protocol.

In some embodiments, the communication method may further include the following operations:
S607: The first terminal obtains a public key certificate of second asymmetric keys.
S608: The first terminal encrypts a second video encryption key through a public key of the public key certificate of the second asymmetric keys, to obtain a sixth encryption result.
S609: The first terminal transmits the sixth encryption result to the second terminal.
S610: The second terminal decrypts the sixth encryption result through a private key of the second asymmetric keys, to obtain the second video encryption key.
S611: The first terminal encrypts a to-be-transmitted video through the second video encryption key, to obtain a second encrypted video.
S612: The first terminal transmits the second encrypted video to the second terminal.
S613: The second terminal decrypts the second encrypted video through the second video encryption key.

It is to be understood that, S607 to S613 may be performed after S606, a combination solution of which is a bidirectional video transmission process. In some embodiments, S607 to S613 may further be directly performed after the path between the first terminal and the second terminal is established, that is, there is no need to be coupled with the solution between S601 to S606.

It is to be understood that, with respect to S607 to S613, reference may be made to an explanation with respect to S601 to S606, and details are not described herein again.

In some embodiments, a P2P video transmission mode or a forwarding-based video transmission mode may be used between the first terminal and the second terminal for video transmission, thereby improving flexibility of video transmission. In addition, if the forwarding-based video transmission mode is used between the first terminal and the second terminal for video transmission, such a mode can support a case in which a plurality of devices watching a video simultaneously, for example, a vehicle terminal may transmit a video to a plurality of user terminals, so that a plurality of users watch an in-vehicle video.

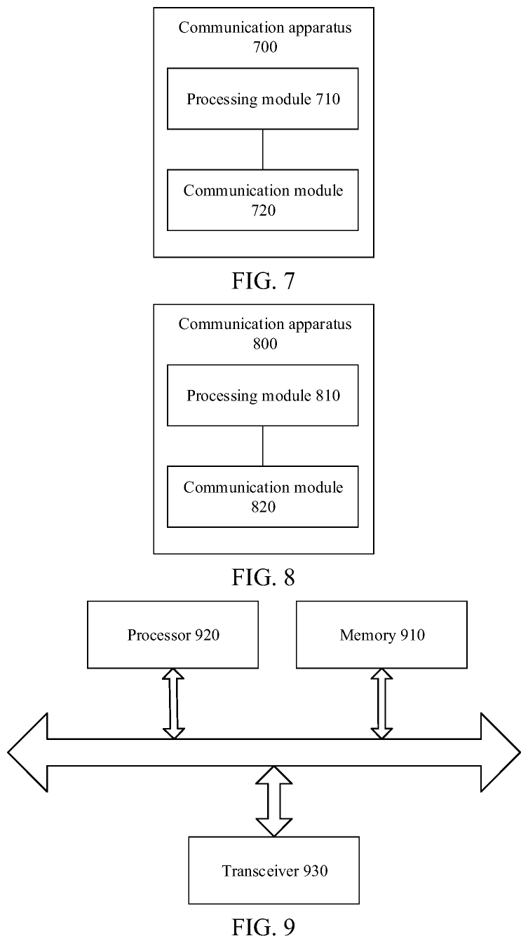

FIG. 7 is a schematic diagram of a communication apparatus 700 according to some embodiments. The communication apparatus is the foregoing first terminal. As shown in FIG. 7, the apparatus 700 may include: a processing module 710 and a communication module 720, where the processing module 710 is configured to access a signaling server to trigger bidirectional authentication between the first terminal and the signaling server; generate a video connection establishment request after the bidirectional authentication between the first terminal and the signaling server succeeds; sign the video connection establishment request; and encrypt the video connection establishment request and a signature of the video connection establishment request, to obtain a first encryption result. The communication module 720 is configured to transmit the first encryption result to the signaling server, so that the signaling server transmits the first encryption result to the second terminal through a mapping relationship between the first terminal and the second terminal.

In some embodiments, the communication module 720 is further configured to receive a second encryption result transmitted by the second terminal through the signaling server, where the second encryption result is an encryption result obtained by encrypting a video connection establishment reply corresponding to the video connection establishment request and a signature of the video connection establishment reply. The processing module 710 is further configured to decrypt the second encryption result, to obtain a video connection establishment reply and the signature of the video connection establishment reply; and perform signature verification on the signature of the video connection establishment reply.

In some embodiments, the video connection establishment request includes: an identifier of a requested video transmission mode. The processing module 710 is further configured to generate a video forwarding interaction request corresponding to a first video transmission mode after it is determined that the video connection establishment negotiation is successful, where the first video transmission mode is a video transmission mode determined based on the identifier of the requested video transmission mode; sign the video forwarding interaction request; encrypt the video forwarding interaction request and a signature of the video forwarding interaction request, to obtain a third encryption result. The communication module 720 is further configured to transmit the third encryption result to the signaling server, so that the signaling server transmits the third encryption result to the second terminal through the mapping relationship between the first terminal and the second terminal.

In some embodiments, the communication module 720 is further configured to receive a fourth encryption result transmitted by the second terminal through the signaling server, where the fourth encryption result is an encryption result obtained by encrypting the video forwarding interaction reply corresponding to the video forwarding interaction request and the signature of the video forwarding interaction reply. The processing module 710 is further configured to decrypt the fourth encryption result, to obtain a video forwarding interaction reply and the signature of the video forwarding interaction reply; and perform signature verification on the signature of the video forwarding interaction reply.

In some embodiments, the first video transmission mode is a P2P video transmission mode or a forwarding-based video transmission mode.

In some embodiments, the video connection establishment request includes: a public key certificate of first asymmetric keys. The communication module 720 is further configured to receive a fifth encryption result transmitted by the second terminal, where the fifth encryption result is an encryption result of encrypting a first video encryption key through a public key of the public key certificate of the first asymmetric keys. The processing module 710 is further configured to decrypt the fifth encryption result through the private key of the first asymmetric keys to obtain the first video encryption key. The communication module 720 is further configured to receive the first encrypted video transmitted by the second terminal. The processing module 710 is further configured to decrypt the first encrypted video through the first video encryption key.

In some embodiments, the communication module 720 is further configured to obtain a public key certificate of second asymmetric keys. The processing module 710 is further configured to encrypt a second video encryption key through a public key of the public key certificate of the second asymmetric keys, to obtain a sixth encryption result. The communication module 720 is further configured to transmit the sixth encryption result to the second terminal. The processing module 710 is further configured to encrypt a to-be-transmitted video through the second video encryption key, to obtain a second encrypted video. The communication module 720 is further configured to transmit the second encrypted video to the second terminal.

It is to be understood that apparatus embodiments and method embodiments may correspond to each other. For a similar description, refer to the method embodiments. To avoid repetition, details are not described herein again. In some embodiments, the apparatus 700 shown in FIG. 7 may perform a method embodiment corresponding to the first terminal, and the foregoing and other operations and/or functions of the modules in the apparatus 700 are respectively intended to implement corresponding procedures in the method embodiment corresponding to the first terminal. For brevity, details are not described herein again.

The apparatus 700 of some embodiments is described above with reference to the accompanying drawings from a perspective of a functional module. It is to be understood that, the functional module may be implemented in hardware form, or may be implemented in software form of instructions, or may be implemented through a combination of hardware and software modules. In some embodiments, operations may be completed by instructions in the form of hardware integrated logic circuits and/or software in the processor, and operations of the methods may be directly performed and completed by using a hardware decoding processor, or may be performed and completed by using a combination of hardware and software modules in the decoding processor. In some embodiments, the software module may be located in a mature storage medium in the art, such as a random access memory, a flash memory, a read-only memory, a programmable read-only memory, an electrically-crasable programmable memory, and a register. The storage medium is located in the memory. The processor reads information in the memory and completes the operations of the foregoing method embodiments in combination with hardware thereof.

FIG. 8 is a schematic diagram of a communication apparatus 800 according to some embodiments. The communication apparatus is the foregoing second terminal. As shown in FIG. 8, the apparatus 800 may include: a processing module 810 and a communication module 820. The processing module 810 is configured to access a signaling server to trigger bidirectional authentication between the second terminal and the signaling server. The communication module 820 is configured to receive a first encryption result transmitted by the signaling server through the mapping relationship between the first terminal and the second terminal after the bidirectional authentication between the second terminal and the signaling server succeeds, where the first encryption result is an encryption result obtained by encrypting a video connection establishment request and a signature of the video connection establishment request. The processing module 810 is further configured to decrypt the first encryption result, to obtain the video connection establishment request and the signature of the video connection establishment request. The processing module 810 is further configured to perform signature verification on the signature of the video connection establishment request.

In some embodiments, the processing module 810 is further configured to generate a video connection establishment reply corresponding to the video connection establishment request; sign the video connection establishment reply; encrypt the video connection establishment reply and a signature of the video connection establishment reply, to obtain a second encryption result. The communication module 820 is further configured to transmit the second encryption result to the signaling server, so that the signaling server transmits the second encryption result to the first terminal through the mapping relationship between the first terminal and the second terminal.

In some embodiments, the video connection establishment request includes: an identifier of a requested video transmission mode. The communication module 820 is further configured to receive a third encryption result transmitted by the signaling server through the mapping relationship between the first terminal and the second terminal after it is determined that the video connection establishment negotiation is successful, where the third encryption result is an encryption result obtained by encrypting a video forwarding interaction request and a signature of the video forwarding interaction request, the first video transmission mode is a video transmission mode determined based on the identifier of the requested video transmission mode. The processing module 810 is further configured to decrypt the third encryption result, to obtain the video forwarding interaction request and the signature of the video forwarding interaction request; and perform signature verification on the signature of the video forwarding interaction request.

In some embodiments, the processing module 810 is further configured to generate a video forwarding interaction reply corresponding to the video forwarding interaction request; sign the video forwarding interaction reply; and encrypt the video forwarding interaction reply and the signature of the video forwarding interaction reply, to obtain a fourth encryption result. The communication module 820 is further configured to transmit the fourth encryption result to the signaling server, so that the signaling server transmits the fourth encryption result to the first terminal through the mapping relationship between the first terminal and the second terminal.

In some embodiments, the video transmission mode is a P2P video transmission mode or a forwarding-based video transmission mode.

In some embodiments, the video connection establishment request includes: a public key certificate of first asymmetric keys. The processing module 810 is further configured to encrypt the first video encryption key through the public key of the public key certificate of the first asymmetric keys, to obtain a fifth encryption result. The communication module 820 is further configured to transmit the fifth encryption result to the first terminal. The processing module 810 is further configured to encrypt the to-be-transmitted video through the first video encryption key, to obtain a first encrypted video. The communication module 820 is further configured to transmit the first encrypted video to the first terminal.

In some embodiments, the communication module 820 is further configured to transmit a public key certificate of second asymmetric keys to the first terminal; receive a sixth encryption result transmitted by the first terminal, where the sixth encryption result is an encryption result of encrypting the second video encryption key through the public key of the public key certificate of the second asymmetric keys. The processing module 810 is further configured to decrypt the sixth encryption result through the private key of the second asymmetric keys to obtain a second video encryption key. The communication module 820 is further configured to receive the second encrypted video transmitted by the second terminal. The processing module 810 is further configured to decrypt the second encrypted video through the second video encryption key.

It is to be understood that apparatus embodiments and method embodiments may correspond to each other. For a similar description, refer to the method embodiments. To avoid repetition, details are not described herein again. In some embodiments, the apparatus 800 shown in FIG. 8 may perform a method embodiment corresponding to the second terminal, and the foregoing and other operations and/or functions of the modules in the apparatus 800 are respectively intended to implement corresponding procedures in the method embodiment corresponding to the second terminal. For brevity, details are not described herein again.

The apparatus 800 of some embodiments is described above with reference to the accompanying drawings from a perspective of a functional module. It is to be understood that, the functional module may be implemented in hardware form, or may be implemented in software form of instructions, or may be implemented through a combination of hardware and software modules. In some embodiments, operations may be completed by instructions in the form of hardware integrated logic circuits and/or software in the processor, and operations may be directly performed and completed by using a hardware decoding processor, or may be performed and completed by using a combination of hardware and software modules in the decoding processor. In some embodiments, the software module may be located in a mature storage medium in the art, such as a random access memory, a flash memory, a read-only memory, a programmable read-only memory, an electrically-erasable programmable memory, and a register. The storage medium is located in the memory. The processor reads information in the memory and completes the steps of the foregoing method embodiments in combination with hardware thereof.

FIG. 9 is a schematic block diagram of an electronic device 900 according to some embodiments.

As shown in FIG. 9, the electronic device 900 may include:
a memory 910 and a processor 920, where the memory 910 is configured to store a computer program and transmit program code to the processor 920. In other words, the processor 920 may invoke and run the computer program from the memory 910 to implement the method in the embodiments of this application.

For example, the processor 920 may be configured to perform the foregoing method embodiment based on instructions in the computer program.

In some embodiments, the processor 920 may include, but not limited to:
a general processor, a digital signal processor (DSP), an application specific integrated circuit (ASIC), a field programmable gate array (FPGA), another programmable logic device, a discrete gate, a transistor logic device, or a discrete hardware component.

In some embodiments, the memory 910 includes, but not limited to:
a non-volatile and/or volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random access memory (RAM), used as an external cache. Through example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), and a direct rambus dynamic random access memory (DR RAM).

In some embodiments, the computer program may be divided into one or more modules, and the one or more modules are stored in the memory 910 and executed by the processor 920 to perform the methods provided in this application. The one or more modules may be a series of computer program instruction segments capable of performing a particular function, and the instruction segments are configured for describing the execution of the computer program in the electronic device.

As shown in FIG. 9, the electronic device may further include:
a transceiver 930, where the transceiver 930 may be connected to the processor 920 or the memory 910.

The processor 920 may control the transceiver 930 to communicate with another device, and specifically, may transmit information or data to another device or receive information or data transmitted by another device. The transceiver 930 may include a transmitter and a receiver. The transceiver 930 may further include an antenna, and a quantity of antennas may be one or more.

It is to be understood that, various components of the electronic device are connected to each other by using a bus system. In addition to including a data bus, the bus system further includes a power bus, a control bus, and a status signal bus.

Some embodiments provide a computer storage medium, where the computer storage medium stores a computer program, and when the computer program is executed by a computer, the method in any one of the foregoing embodiments is implemented by the computer. Some embodiments further provide a computer program product including instructions. When the instructions executed by a computer, the computer is caused to perform the method according to the foregoing method embodiments.

When software is used to implement embodiments, all or a part of the embodiments may be implemented in a form of a computer program product. The computer program product includes one or more computer instructions. When the computer program instructions are loaded and executed on the computer, all or some of the steps are generated according to the process or function described in the embodiments of this application. The computer may be a general-purpose computer, a special-purpose computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server or data center to another website, computer, server or data center in a wired (for example, a coaxial cable, an optical fiber or a digital subscriber line (DSL)) or wireless (for example, infrared, wireless or microwave) manner. The computer-readable storage medium may be any usable medium accessible by the computer, or a data storage device, for example, a server or a data center, integrating one or more usable media. The available medium may be a magnetic medium (such as a floppy disk, a hard disk, or a magnetic tape), an optical medium (such as a digital video disc (DVD)), a semiconductor medium (such as a solid state disk (SSD)) or the like.

A person of ordinary skill in the art may be aware that, in combination with the examples described in the embodiments disclosed, modules and algorithm operations may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the disclosure.

It should be understood that the disclosed system, apparatus, and method may be implemented in other manners. For example, the described apparatus embodiment is merely exemplary. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented by using some interfaces. The indirect couplings or communication connections between the apparatuses or modules may be implemented in electronic, mechanical, or other forms.

The modules described as separate parts may or may not be physically separate, and parts displayed as modules may or may not be physical modules, may be located in one position, or may be distributed on a plurality of network units. Some or all of the modules may be selected according to actual requirements to implement the objectives of the solutions of the embodiments. For example, functional modules in embodiments may be integrated into one processing module, or each of the modules may exist alone physically, or two or more modules may be integrated into one module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A communication method, performed by a first terminal, comprising:
accessing a signaling server to trigger bidirectional authentication between the first terminal and the signaling server;
generating a video connection establishment request based on the bidirectional authentication between the first terminal and the signaling server succeeding;
signing the video connection establishment request;
encrypting the video connection establishment request and a signature of the video connection establishment request to obtain a first encryption result; and
transmitting the first encryption result to a second terminal via the signaling server.

2. The communication method according to claim 1, further comprising:
receiving a second encryption result transmitted by the second terminal through the signaling server, the second encryption result being an encryption result obtained by encrypting a video connection establishment reply corresponding to the video connection establishment request and a signature of the video connection establishment reply;
decrypting the second encryption result to obtain the video connection establishment reply and the signature of the video connection establishment reply; and
performing signature verification on the signature of the video connection establishment reply.

3. The communication method according to claim 1, wherein the video connection establishment request comprises an identifier of a requested video transmission mode, and
wherein the communication method further comprises:
based on a determination that video connection establishment negotiation is successful, generating a video forwarding interaction request corresponding to a first video transmission mode, the first video transmission mode being a video transmission mode determined based on the identifier of the requested video transmission mode;
signing the video forwarding interaction request;
encrypting the video forwarding interaction request and a signature of the video forwarding interaction request, to obtain a third encryption result; and
transmitting the third encryption result to the second terminal via the signaling server.

4. The communication method according to claim 3, further comprising:
receiving a fourth encryption result transmitted by the second terminal through the signaling server, the fourth encryption result being an encryption result obtained by encrypting a video forwarding interaction reply corresponding to the video forwarding interaction request and a signature of the video forwarding interaction reply;
decrypting the fourth encryption result to obtain the video forwarding interaction reply and the signature of the video forwarding interaction reply; and
performing signature verification on the signature of the video forwarding interaction reply.

5. The communication method according to claim 3, wherein the first video transmission mode is a point-to-point (P2P) video transmission mode or a forwarding-based video transmission mode.

6. The communication method according to claim 1, wherein the video connection establishment request comprises a public key certificate of first asymmetric keys, and the communication method further comprises:
receiving a fifth encryption result transmitted by the second terminal, the fifth encryption result being an encryption result of encrypting a first video encryption key through a public key of the public key certificate of the first asymmetric keys;
decrypting the fifth encryption result through a private key of the first asymmetric keys to obtain the first video encryption key;
receiving a first encrypted video transmitted by the second terminal; and
decrypting the first encrypted video through the first video encryption key.

7. The communication method according to claim 1, further comprising:
obtaining a public key certificate of second asymmetric keys;
encrypting a second video encryption key through a public key of the public key certificate of the second asymmetric keys, to obtain a sixth encryption result;
transmitting the sixth encryption result to the second terminal;
encrypting a to-be-transmitted video through the second video encryption key to obtain a second encrypted video; and
transmitting the second encrypted video to the second terminal.

8. A communication apparatus comprising:
at least one memory configured to store program code; and
at least one processor configured to read the program code and operate as instructed by the program code, the program code comprising:
processing code configured to cause at least one of the at least one processor to:
access a signaling server to trigger bidirectional authentication between a first terminal and the signaling server;
generate a video connection establishment request based on the bidirectional authentication between the first terminal and the signaling server succeeding;
sign the video connection establishment request; and
encrypt the video connection establishment request and a signature of the video connection establishment request to obtain a first encryption result; and
communication code configured to cause at least one of the at least one processor to:
transmit the first encryption result to a second terminal via the signaling server.

9. The communication apparatus according to claim 8, wherein the communication code is further configured to cause at least one of the at least one processor to:
receive a second encryption result transmitted by the second terminal through the signaling server, the second encryption result being an encryption result obtained by encrypting a video connection establishment reply corresponding to the video connection establishment request and a signature of the video connection establishment reply; and
wherein the processing code is further configured to cause at least one of the at least one processor to:
decrypt the second encryption result to obtain the video connection establishment reply and the signature of the video connection establishment reply; and
perform signature verification on the signature of the video connection establishment reply.

10. The communication apparatus according to claim 8, wherein the video connection establishment request comprises an identifier of a requested video transmission mode;
wherein the processing code is further configured to cause at least one of the at least one processor to:
based on a determination that video connection establishment negotiation is successful, generate a video forwarding interaction request corresponding to a first video transmission mode, the first video transmission mode being a video transmission mode determined based on the identifier of the requested video transmission mode,
sign the video forwarding interaction request, and
encrypt the video forwarding interaction request and a signature of the video forwarding interaction request, to obtain a third encryption result; and
wherein the communication code is further configured to cause at least one of the at least one processor to:
transmit the third encryption result to the second terminal via the signaling server.

11. The communication apparatus according to claim 10, wherein the communication code is further configured to cause at least one of the at least one processor to:
receive a fourth encryption result transmitted by the second terminal through the signaling server, the fourth encryption result being an encryption result obtained by encrypting a video forwarding interaction reply corresponding to the video forwarding interaction request and a signature of the video forwarding interaction reply; and
wherein the processing code is further configured to cause at least one of the at least one processor to:
decrypt the fourth encryption result to obtain the video forwarding interaction reply and the signature of the video forwarding interaction reply; and
perform signature verification on the signature of the video forwarding interaction reply.

12. The communication apparatus according to claim 10, wherein the first video transmission mode is a point-to-point (P2P) video transmission mode or a forwarding-based video transmission mode.

13. The communication apparatus according to claim 8, wherein the video connection establishment request comprises a public key certificate of first asymmetric keys; and wherein the communication code is further configured to cause at least one of the at least one processor to receive a fifth encryption result transmitted by the second terminal, the fifth encryption result being an encryption result of encrypting a first video encryption key through a public key of the public key certificate of the first asymmetric keys;
the processing code is further configured to cause at least one of the at least one processor to decrypt the fifth encryption result through a private key of the first asymmetric keys to obtain the first video encryption key;
the communication code is further configured to cause at least one of the at least one processor to receive a first encrypted video transmitted by the second terminal; and
the processing code is further configured to cause at least one of the at least one processor to decrypt the first encrypted video through the first video encryption key.

14. The communication apparatus according to claim 8, wherein
the communication code is further configured to cause at least one of the at least one processor to obtain a public key certificate of second asymmetric keys;
the processing code is further configured to cause at least one of the at least one processor to encrypt a second video encryption key through a public key of the public key certificate of the second asymmetric keys, to obtain a sixth encryption result;
the communication code is further configured to cause at least one of the at least one processor to transmit the sixth encryption result to the second terminal;
the processing code is further configured to cause at least one of the at least one processor to encrypt a to-be-transmitted video through the second video encryption key to obtain a second encrypted video; and
the communication code is further configured to cause at least one of the at least one processor to transmit the second encrypted video to the second terminal.

15. A non-transitory computer-readable storage medium, storing computer code which, when executed by at least one processor, causes at least one of the at least one processor to at least:
access a signaling server to trigger bidirectional authentication between the first terminal and the signaling server;
generate a video connection establishment request based on the bidirectional authentication between the first terminal and the signaling server succeeding;
sign the video connection establishment request;
encrypt the video connection establishment request and a signature of the video connection establishment request to obtain a first encryption result; and
transmit the first encryption result to a second terminal via the signaling server.

16. The non-transitory computer-readable storage medium according to claim 15, wherein the computer code further causes at least one of the at least one processor to at least:
receive a second encryption result transmitted by the second terminal through the signaling server, the second encryption result being an encryption result obtained by encrypting a video connection establishment reply corresponding to the video connection establishment request and a signature of the video connection establishment reply;
decrypt the second encryption result to obtain the video connection establishment reply and the signature of the video connection establishment reply; and
perform signature verification on the signature of the video connection establishment reply.

17. The non-transitory computer-readable storage medium according to claim 15, wherein the video connection establishment request comprises an identifier of a requested video transmission mode, and wherein the computer code further causes at least one of the at least one processor to at least:
based on a determination that video connection establishment negotiation is successful, generate a video forwarding interaction request corresponding to a first video transmission mode, the first video transmission mode being a video transmission mode determined based on the identifier of the requested video transmission mode;
sign the video forwarding interaction request;
encrypt the video forwarding interaction request and a signature of the video forwarding interaction request, to obtain a third encryption result; and
transmit the third encryption result to the second terminal via the signaling server.

18. The non-transitory computer-readable storage medium according to claim 17, wherein the computer code further causes at least one of the at least one processor to at least:
receive a fourth encryption result transmitted by the second terminal through the signaling server, the fourth encryption result being an encryption result obtained by encrypting a video forwarding interaction reply corresponding to the video forwarding interaction request and a signature of the video forwarding interaction reply;
decrypt the fourth encryption result to obtain the video forwarding interaction reply and the signature of the video forwarding interaction reply; and
perform signature verification on the signature of the video forwarding interaction reply.

19. The non-transitory computer-readable storage medium according to claim 15, wherein the video connection establishment request comprises a public key certificate of first asymmetric keys, and wherein the computer code further causes at least one of the at least one processor to at least:
receive a fifth encryption result transmitted by the second terminal, the fifth encryption result being an encryption result of encrypting a first video encryption key through a public key of the public key certificate of the first asymmetric keys;
decrypt the fifth encryption result through a private key of the first asymmetric keys to obtain the first video encryption key;
receive a first encrypted video transmitted by the second terminal; and
decrypt the first encrypted video through the first video encryption key.

20. The non-transitory computer-readable storage medium according to claim 15, wherein the computer code further causes at least one of the at least one processor to at least:
obtain a public key certificate of second asymmetric keys;
encrypt a second video encryption key through a public key of the public key certificate of the second asymmetric keys, to obtain a sixth encryption result;
transmit the sixth encryption result to the second terminal;
encrypt a to-be-transmitted video through the second video encryption key to obtain a second encrypted video; and
transmit the second encrypted video to the second terminal.
